(19) United States
(12) Patent Application Publication
(10) Pub. No.: US 2014/0008305 A1
(43) Pub. Date: Jan. 9, 2014

(54) METHOD FOR REMOVING SULFATE ANIONS FROM AN AQUEOUS SOLUTION

(71) Applicants: Everett J. Nichols, Edmonds, WA (US); James R. Scott, Bellevue, WA (US)

(72) Inventors: Everett J. Nichols, Edmonds, WA (US); James R. Scott, Bellevue, WA (US)

(73) Assignee: HALOSOURCE, INC., Bothell, WA (US)

(21) Appl. No.: 13/909,931

(22) Filed: Jun. 4, 2013

Related U.S. Application Data
(60) Provisional application No. 61/655,305, filed on Jun. 4, 2012.

(51) Int. Cl. C02F 1/52

(52) U.S. Cl. CPC C02F 1/52
USPC 210/725; 210/728

(57) ABSTRACT

A method includes the steps, adding divalent calcium to an aqueous medium containing sulfate anions in solution and forming insoluble calcium sulfate in the aqueous medium; adding a water-soluble chitosan to the aqueous medium and forming a chitosan sulfate complex; adding a water-soluble anionic polymer to the aqueous medium to form aggregates comprising the chitosan sulfate complex with the anionic polymer; andremoving the aggregates from the aqueous medium to remove the sulfate anions.

### CROSS-REFERENCE TO RELATED APPLICATION

This application claims the benefit of U.S. Provisional Application No. 61/655,305, filed Jun. 4, 2012, which is fully incorporated herein expressly by reference.

### BACKGROUND

Sulfate anions (SO₄²⁻) are encountered in a variety of aqueous solutions. Produced water from enhanced oil recovery contains high concentrations of sulfate. It is often found in produced water, drill water, and flow back water derived from oil and gas mining operations. High concentrations of sulfate are also encountered in mineral processing water. Sulfate can be detrimental to equipment and has been reported to cause pitting and corrosion in stainless steel steam turbine blades. It is desired to remove sulfate from these waters. Recommended discharge limits exist for sulfate concentrations in water, particularly for drinking water. Sulfate pollution can also negatively impact aquatic ecosystems. Calcium chloride is known to react with sulfate anions to form insoluble calcium sulfate. Hydrated lime (calcium hydroxide) is commonly used commercially to remove sulfate from water through precipitation of calcium sulfate (gypsum). The amount of sulfate that can be removed by precipitation of calcium sulfate is limited due to the solubility product constant of calcium sulfate. It is therefore difficult to reduce concentrations of sulfate anions lower than approximately 1,000-1,5000 ppm using calcium ions. Other methods to reduce sulfate below 2,000 mg/L include ion exchange or reverse osmosis but these are expensive methods and generate large volumes of water that must be treated.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a method for removing sulfate anions in solution from an aqueous medium is disclosed. The method includes the steps:
(a) adding divalent calcium to an aqueous medium containing sulfate anions in solution and forming insoluble calcium sulfate in the aqueous medium;
(b) adding a water-soluble chitosan to the aqueous medium and forming a chitosan sulfate complex;
(c) adding a water-soluble anionic polymer to the aqueous medium to form aggregates comprising the chitosan sulfate complex with the anionic polymer; and
(d) filtering the aggregates from the aqueous medium to remove the sulfate anions.

The method of filtration can include the use of a filter, such as via a 150 μm filter.

In some embodiments, the chitosan sulfate complex is allowed to precipitate in step (b).

In some embodiments, the divalent calcium is comprised in calcium acetate (Ca²⁺(C₂H₃O₂⁻)₂) or any hydrate or solution thereof.

In some embodiments, the divalent calcium is comprised in calcium chloride (Ca²⁺Cl₂) or any hydrate or solution thereof.

In some embodiments, the chitosan is at least 50% deacetylated.

In some embodiments, the chitosan is in solution.

In some embodiments, the chitosan is added as a solution comprising acetic acid and water.

In some embodiments, the chitosan is added as a dry free flowing salt.

In some embodiments, the anionic polymer is carboxymethylcellulose, alginate, polyacrylic acid, polyacrylamide, xanthan gum, or any combination thereof.

In some embodiments, a concentration of the sulfate is 1,000 ppm to 1,500 ppm by weight or greater.

In some embodiments, the method further includes raising the pH of the aqueous medium before adding the chitosan.

In some embodiments, the method further includes raising the pH of the aqueous medium after adding the chitosan.

In some embodiments, the method further includes lowering the pH of the aqueous medium after adding the chitosan.

In some embodiments, the sulfate ion concentration is reduced to below 1,000 ppm by weight.

In some embodiments, the sulfate ion concentration is reduced to below 1,500 ppm by weight.

In some embodiments, a method for removing sulfate anions in solution from an aqueous medium is disclosed. The method includes the steps:
(a) adding a water-soluble chitosan to an aqueous medium containing a concentration of about 1000 ppm by weight or less sulfate anions in solution;
(b) adding a water-soluble anionic polymer to the aqueous medium to form aggregates comprising a chitosan sulfate complex with the anionic polymer; and
(c) removing the aggregates from the aqueous medium to remove the sulfate anions.

In some embodiments, a method for removing sulfate anions in solution from an aqueous medium is disclosed. The method includes the steps:
(a) adding divalent alkaline earth metal to an aqueous medium containing sulfate anions in solution and forming insoluble sulfate compound in the aqueous medium;
(b) adding a water-soluble chitosan to the aqueous medium and forming a chitosan sulfate complex;
(c) adding a water-soluble anionic polymer to the aqueous medium to form aggregates comprising the chitosan sulfate complex with the anionic polymer; and
(d) removing the aggregates from the aqueous medium to remove the sulfate anions.

In some embodiments, the anionic polymer is carboxymethylcellulose, alginate, polyacrylic acid, polyacrylamide, xanthan gum, or any combination thereof.

### DETAILED DESCRIPTION

Chitosan is derived from chitin. Chitin is a polymer that occurs widely in nature and is a principal constituent of the exoskeleton of many arthropods and insects and of the cell wall of many fungi. It is frequently found in a mixture with proteins and calcium compounds. Chitin is essentially a polymer of 2-deoxy-2-acetamidoglucose monomer units that are linked in beta-1,4 fashion though a minor fraction of the units may be hydrolyzed to 2-deoxy-2-aminoglucose units. The term chitosan is generally applied to copolymers having greater than 50% 2-deoxy-2-aminoglucose monomeric units, and the remaining monomeric units are 2-deoxy-2-acetamidoglucose units. Chitosan is derived from chitin by hydrolysis of some 2-deoxy-2-acetamidoglucose units to 2-deoxy-2-aminoglucose units. Due to the presence of a greater number of free amino groups, chitosan is soluble in aqueous acidic solutions, such as dilute acetic acid, and is present in such media as a polycation with the protonated amino groups bearing a positive charge. Chitosan useful in the method disclosed herein typically has a molecular weight in the range of from 20,000 Daltons to two million Daltons, such as from 50,000 Daltons to one million Daltons, or such as from 100,000 Daltons to 900,000 Daltons. Chitosan that is useful in the disclosed methods typically has a percentage deacetylation of from 50% to 100%, such as from 60% to 95%, or from 70% to 90%. Chitosan for use in the disclosed methods may be provided as a salt of chitosan with a C₁ to C₁₈ mono-or polycarboxylic acid, such as chitosan acetate or chitosan lactate. By way of non-limiting example, chitosan salts useful in the practice of the disclosed methods include: chitosan glutamate, chitosan hydrochloride, chitosan succinate, chitosan fumarate, chitosan adipate, chitosan glycolate, chitosan tartrate, chitosan formate, chitosan malate, chitosan lactate, chitosan pyruvate, and chitosan citrate. Chitosan, provided either in solution or as a solid, dry free-flowing salt, can be used in the embodiments disclosed herein.

When provided in chitosan composition, the chitosan may comprise about, at most about, or at least about a weight percent of 0.1, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71, 71.5, 72, 72.5, 73, 73.5, 74, 74.5, 75, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, 90, 90.5, 91, 91.5, 92, 92.5, 93, 93.5, 94, 94.5, 95, 95.6, 97, 97.5, 98, 98.5, 99, 99.5% or 100%, of the composition, or any range derivable therein.

Chitosan in protonated form is able to react with sulfate anions forming a precipitated complex. The cloudy turbid solution of precipitated chitosan sulfate complex can be flocculated using an anionic polymer. Representative soluble, anionic, polyelectrolyte flocculant polymers, include alginate, sodium hexametaphosphate, sodium carboxymethylcellulose, pectin, polyacrylic acid, anionic polysaccharides, carrageenan, and polyacrylamide (that is, anionic polyacrylamide). Non-limiting examples of anionic polysaccharides include dextran sulfate, heparin sulfate, chondroitin sulfate, hyaluronic acid, welan gum, gellan gum, furcellaran, anionic starch, sulfated agarose, carboxylated agarose, carboxymethylated chitosan, succinylated chitosan, and xanthan gum. Other soluble, anionic polymers include polyglutamic acid, polygalacturonic acid, and cross-linked polyacrylic acid. In the disclosed methods, a mixture of more than one anionic polymers could also be used instead of only one type.

When provided in a composition, the one or more anionic polymer(s) may comprise about, at most about, or at least about a weight percent of 0.1, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71, 71.5, 72, 72.5, 73, 73.5, 74, 74.5, 75, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, 90, 90.5, 91, 91.5, 92, 92.5, 93, 93.5, 94, 94.5, 95, 95.6, 97, 97.5, 98, 98.5, 99, 99.5% or 100%, of the composition, or any range derivable therein.

Some embodiments of a method for removing sulfate anions (SO₄²⁻) include the following steps. Adding calcium acetate or calcium chloride or any other form of divalent calcium (Ca²⁺) to an aqueous medium containing a concentration of sulfate anions in solution of approximately 1,000-1,500 ppm by weight or greater in order to allow formation of insoluble calcium sulfate. Calcium acetate and calcium chloride are representative examples of compounds having divalent calcium (Ca²+). Calcium is known as an alkaline earth metal, along with beryllium, magnesium, calcium, strontium, barium, and radium. Alkaline earth metals can lose two electrons to form divalent cations. Calcium acetate and calcium chloride can be in one of the various hydrated forms. When provided in a composition, the calcium compound may comprise about, at most about, or at least any weight percent of 0.1 up to 100% by weight. This is then followed by the addition of water-soluble chitosan to the aqueous medium to allow the reaction of sulfate with chitosan forming a cloudy precipitation complex of chitosan sulfate. The water-soluble chitosan can be in solution or a salt as described above. This is then followed by adding a water soluble anionic polymer to the aqueous medium resulting in formation of large aggregate complexes that are then easily removed from the water by settling, filtration, and the like. The combination of using calcium salts with chitosan followed by anionic polymers allows the formation of large sized aggregates that can coarse filtered under higher flow rates that might not be achieved using fine filtration. Methods for removing aggregates from aqueous media via can include filtration using a 150 μm filter, for example.

In some embodiments, the precipitated calcium sulfate can be removed from the aqueous medium before addition of the chitosan.

In some embodiments, the pH of the aqueous medium can be adjusted at the same time or following the addition of the divalent calcium, such as calcium chloride or calcium acetate. The pH could be adjusted to an alkaline pH (greater than 7 to 14) in order to enhance the precipitation of the calcium sulfate. The agent used for adjusting the pH can be any alkaline compound, such as sodium hydroxide, sodium bicarbonate, and the like.

In some embodiments, the pH of the aqueous medium can be adjusted following the addition of the chitosan. The pH could be adjusted to an alkaline pH (greater than 7 to 14) in order to enhance the precipitation of the chitosan sulfate complex.

In some embodiments, the pH of the aqueous medium can be adjusted before or after the addition of the chitosan. The pH could be adjusted to an acidic pH (less than 7) in order to enhance the formation and/or increase the quantity of the chitosan sulfate complex. The pH can be adjusted using an acid, such as hydrochloric acid.

The combination of a divalent calcium compound, such as calcium acetate or calcium chloride, or any hydrated form thereof, with chitosan, followed by aggregate formation with an anionic polymer and filtration, would reduce the sulfate anion concentration below that which could be achieved using calcium ions alone.

In some embodiments, soluble chitosan can be added to the aqueous solution containing sulfate anions that have not been treated with calcium ions. This could be low sulfate concentration solution below 1,000 ppm. This would be followed by the addition of an anionic polymer.

In some embodiments, a method for removing sulfate anions in solution from an aqueous medium is disclosed. The method includes the steps:
(a) adding divalent calcium to an aqueous medium containing sulfate anions in solution and forming insoluble calcium sulfate in the aqueous medium;
(b) adding a water-soluble chitosan to the aqueous medium and forming a chitosan sulfate complex;
(c) adding a water-soluble anionic polymer to the aqueous medium to form aggregates comprising the chitosan sulfate complex with the anionic polymer; and
(d) filtering the aggregates from the aqueous medium to remove the sulfate anions.

In some embodiments, the method of filtration can include the use of a filter, such as via a 150 μm filter.

In some embodiments, the chitosan sulfate complex is allowed to precipitate in step (b).

In some embodiments, the divalent calcium is comprised in calcium acetate (Ca²⁺(C₂H₃O₂⁻)₂) or any hydrate or solution thereof.

In some embodiments, the divalent calcium is comprised in calcium chloride (Ca²⁺Cl₂) or any hydrate or solution thereof.

In some embodiments, the chitosan is at least 50% deacetylated.

In some embodiments, the chitosan is in solution.

In some embodiments, the chitosan is added as a solution comprising acetic acid and water.

In some embodiments, the chitosan is added as a dry free flowing salt.

In some embodiments, the anionic polymer is carboxymethylcellulose, alginate, polyacrylic acid, polyacrylamide, xanthan gum, or any combination thereof.

In some embodiments, a concentration of the sulfate is 1,000 ppm to 1,500 ppm by weight or greater.

In some embodiments, the method further includes raising the pH of the aqueous medium before adding the chitosan.

In some embodiments, the method further includes raising the pH of the aqueous medium after adding the chitosan.

In some embodiments, the method further includes lowering the pH of the aqueous medium following the addition of the chitosan.

In some embodiments, the sulfate ion concentration is reduced to below 1,000 ppm by weight.

In some embodiments, the sulfate ion concentration is reduced to below 1,500 ppm by weight.

In some embodiments, a method for removing sulfate anions in solution from an aqueous medium is disclosed. The method includes the steps:
(a) adding a water-soluble chitosan to an aqueous medium containing a concentration of about 1000 ppm by weight or less sulfate anions in solution;
(b) adding a water-soluble anionic polymer to the aqueous medium to form aggregates comprising a chitosan sulfate complex with the anionic polymer; and
(c) removing the aggregates from the aqueous medium to remove the sulfate anions.

In some embodiments, a method for removing sulfate anions in solution from an aqueous medium is disclosed. The method includes the steps:
(a) adding divalent alkaline earth metal to an aqueous medium containing sulfate anions in solution and forming insoluble sulfate compound in the aqueous medium;
(b) adding a water-soluble chitosan to the aqueous medium and forming a chitosan sulfate complex;
(c) adding a water-soluble anionic polymer to the aqueous medium to form aggregates comprising the chitosan sulfate complex with the anionic polymer; and
(d) removing the aggregates from the aqueous medium to remove the sulfate anions.

In some embodiments, the anionic polymer is carboxymethylcellulose, alginate, polyacrylic acid, polyacrylamide, xanthan gum, or any combination thereof.

Any embodiment herein may comprise, consist essentially of, or consist of components, ingredients, and steps, etc. With respect to “consist essential of,” such embodiments are drawn to the specified components, ingredients, steps, etc., and those that do not materially affect the basic and novel characteristics of the claimed invention.

In this application, the term “about” is used to indicate that a value includes the standard deviation of error for the device or method being employed to determine the value. In any embodiment discussed in the context of a numerical value used in conjunction with the term “about,” it is specifically contemplated that the term about can be omitted.

Following long-standing patent law, the words “a” and “an,” when used in conjunction with the word “comprising” in the claims or specification, denotes one or more, unless specifically noted.

### EXAMPLES

A solution of sodium sulfate targeting 3000 ppm of sulfate ion (SO₄⁻²) was made. The solution used 4.44 gm of sodium sulfate per liter of de-ionized water and was mixed overnight. The sulfate solution contained 2900 ppm of sulfate ion (SO₄) as measured by the Hach spectrophotometer using SulfaVer 4 reagent. This method uses barium chloride in which the barium ion reacts with sulfate ion to form an insoluble barium sulfate precipitate. The turbidity of the barium sulfate solution can be used to determine the concentration of sulfate.

### Example A

Poured four 100 ml samples of the 2900 ppm sulfate solution into four separate containers and labeled them 1 through 4. Made three separate solutions each containing 2.9 g CaCl₂×2H₂O in 2.1 g of DI water. Added one of the CaCl₂×2H₂O solutions to each of 100 ml of sulfate solution (SO₄ 2900 ppm), labeled 2 through 4. All containers were continually mixed following the addition of the respective chemicals, until the solutions where filtered. White precipitates (CaSO₄) formed in each of the containers labeled 2 through 4. Container 1 (control) did not have any CaCl₂×2H₂O solution added to it.

To container 3 and 4, 1 mL of 1% chitosan acetate solution was added and mixed for one hour at ambient temperature. After one hour, 1 ml of 1% xanthan gum solution was added to container 4 and the solution continued to mix for one more hour. During mixing large flocs were observed in container 4.

All solutions in containers 1 through 4 were immediately gravity filtered through a 150 μm filter. An aliquot of each filtrate from containers 1 through 4, was tested for sulfate concentration using the Hach spectrophotometer and SulfaVer 4 reagent. The results are presented in Table 1 below:

TABLE 1

| | | Chitosan | Xanthan | |
|---|---|---|---|---|
| Container | CaCl2 | Acetate | Gum | Sulfate conc of |
| Number | added | added | Added | Filtrate (ppm) |
| 1 | No | No | No | 2900 |
| 2 | Yes | No | No | 1950 |
| 3 | Yes | Yes | No | 1450 |
| 4 | Yes | Yes | Yes | 500 |

Results: Results in Table 1 demonstrate that the sequential combination of calcium, chitosan and xanthan significantly reduced sulfate concentration to below 1000 ppm. This is in contrast to what was achieved by calcium alone or the combination of calcium with chitosan.

While illustrative embodiments have been illustrated and described, it will be appreciated that various changes can be made therein without departing from the spirit and scope of the invention.

1. A method for removing sulfate anions in solution from an aqueous medium, comprising:
(a) adding calcium to an aqueous medium containing sulfate anions in solution and forming insoluble calcium sulfate in the aqueous medium;
(b) adding a water-soluble chitosan to the aqueous medium and forming a chitosan sulfate complex;
(c) adding a water-soluble anionic polymer to the aqueous medium to form aggregates comprising the chitosan sulfate complex with the anionic polymer; and
(d) filtering the aggregates from the aqueous medium to remove the sulfate anions.

2. The method of claim 1, wherein the chitosan sulfate complex is allowed to precipitate in step (b).

3. The method of claim 1, wherein the calcium is comprised in calcium acetate (Ca²⁺(C₂H₃O₂⁻)₂).

4. The method of claim 1, wherein the divalent calcium is comprised in calcium chloride (Ca²⁺Cl₂⁻).

5. The method of claim 1, wherein the chitosan is protonated.

6. The method of claim 1, wherein the anionic polymer is carboxymethylcellulose, alginate, polyacrylic acid, polyacrylamide, xanthan gum, or any combination thereof.

7. The method of claim 1, wherein a concentration of the sulfate in step (a) is over 1,000 ppm to 1,500 ppm or greater.

8. The method of claim 1, further comprising raising the pH of the aqueous medium with or after adding the calcium.

9. The method of claim 1, further comprising adjusting the pH of the aqueous medium after adding the chitosan to enhance precipitation of the chitosan complex.
